(19) United States
(12) Patent Application Publication
(10) Pub. No.: US 2014/0104183 A1
(43) Pub. Date: Apr. 17, 2014

(54) METHOD AND DEVICE FOR CONTROLLING AT LEAST ONE APPARATUS BY AT LEAST ONE OTHER APPARATUS, SYSTEM IMPLEMENTING SUCH A DEVICE

(71) Applicants: Francois Caron, Chesnay (FR); Marc Bernard De Courville, Paris (FR); Raul Mallart, Paris (FR)

(72) Inventors: Francois Caron, Chesnay (FR); Marc Bernard De Courville, Paris (FR); Raul Mallart, Paris (FR)

(73) Assignee: ARCHOS, Igny (FR)

(21) Appl. No.: 13/516,980

(22) PCT Filed: Feb. 2, 2012
(86) PCT No.: PCT/FR12/50233

§ 371 Date: Jun. 18, 2012

(30) Foreign Application Priority Data
May 9, 2011 (FR) 1153966

(51) Int. Cl. G09G 5/00

(52) U.S. Cl. CPC G09G 5/006
USPC 345/173

(57) ABSTRACT

A device for controlling at least one so-called slave apparatus, by at least one so-called master apparatus, including a tactile user interface, the device including: first apparatus for transmitting at least one so-called controlled image, generated by the at least one slave apparatus to the at least one master apparatus for displaying the at least one controlled image on the at least one master apparatus; second apparatus for transmitting, from at least one master apparatus to the at least one slave apparatus, at least one coordinate of at least one tactile selection performed on the at least one master apparatus with respect to the at least one controlled image; and a processing apparatus for interpreting the at least one tactile selection at the at least one slave apparatus as a function of the at least one coordinate.

### TECHNICAL FIELD

The present invention relates to a method and a device for controlling at least one so-called slave apparatus by at least one other so-called master apparatus. It also relates to a system implementing such a control device. The field of the invention is, in a non-limiting way, that of user interfaces and more particularly the field of remote control of a tactile interface using an auxiliary tactile screen.

### STATE OF PRIOR ART

The background of the invention is that of tactile user interfaces and that of wireless remote controllers for audio and/or video equipment, for example a television.

More and more equipment use user interfaces on a tactile screen. This is particularly true in the case of mobile phones but also for multimedia tablets or some PCs.

The feature of these interfaces as compared to user interfaces based on a mouse is that there is no need to display a cursor on a tactile screen. Indeed, in the case of an interface with a mouse, displaying the cursor is made necessary because the mouse moves on a surface which is not the screen and the user's eye makes part of the control loop. This gives a visual feedback of the mouse position to the user.

In the case of a tactile screen, this visual feedback is unnecessary because it is the user's finger that touches the screen: this is a foresight natural situation. Consequently user interfaces on a tactile screen are not developed to display a cursor.

The invention also lies in the background where a mobile multimedia object such as a phone or a tablet can have a high storage capacity and can be used to connect to content servers or the Internet.

Besides, since the screen of this equipment is generally of a small dimension, as compared to a TV screen, it is natural to want to connect them to a greater dimension screen so as to benefit from a better visual comfort or to allow several people to view the contents. To that end, these portable apparatuses are sometimes equipped with means for connecting to a television, such as a HDMI output. These connections are most often but non exclusively wired.

Another feature of the tactile screen interfaces is the necessary proximity between screen and user. This proximity can be defined by a maximum distance which is a user arm length.

Therefore, there is an issue of the remote control of the tactile screen equipment when this equipment is connected by a wire connection to another equipment, for example a television. Indeed, this equipment should be laid near the television and the user is located at a distance, for example on a sofa.

The remote control means according to the state of the art are wireless mice, tactile keypad remote controllers or even tactile screen remote controllers. These solutions enable a cursor to be controlled on the screen (mouse and tactile keypad) or a user interface which is adapted to the contemplated applicative background to be displayed. For example, to control a slide show application, a user interface can be displayed on the screen with specialized controls (following image, preceding image, volume, standby . . . ).

This state of the art is limiting in that the apparatus to be controlled does not know the notion of cursor on the screen.

Furthermore, this is a programmable apparatus which can run an almost infinite number of different applications, which hence cannot be provided beforehand upon designing the remote controller and specialized interfaces. Finally, it would be a mistake to believe that any application developed for tablets will have a corresponding interface on the remote control.

One purpose of the present invention is to provide a method and a device for controlling a so-called slave apparatus, by a tactile so-called master apparatus, enabling an application run by the slave apparatus from the master apparatus to be controlled even if this application was not designed to operate with this master apparatus.

One purpose of the present invention is to provide a method and a device for controlling a so-called slave apparatus, by a tactile so-called master apparatus, not requiring a transfer or simulation of the user interface of the slave apparatus at the master apparatus.

Another purpose of the present invention is to provide a method and a device for controlling a slave apparatus by a tactile master apparatus which is easier and quicker to be used than current methods and devices.

Another object of the present invention is to provide a method and a device for controlling a slave apparatus by a tactile master apparatus requiring fewer resources than current methods and devices.

### DESCRIPTION OF THE INVENTION

At least one of the abovementioned purposes is achieved with a device for controlling at least one so-called slave apparatus, by at least one so-called master apparatus, comprising a tactile user interface, said device being characterised in that it comprises:
first means for transmitting at least one so-called control image, generated by the at least one slave apparatus to said at least one master apparatus for displaying the at least one control image on said at least one master apparatus;
second means for transmitting, from said at least one master apparatus to said at least one slave apparatus, at least one coordinate of at least one tactile selection performed on said at least one master apparatus with respect to said at least one control image; and
processing means for interpreting said at least one tactile selection at said at least one slave apparatus as a function of said at least one coordinate.

Thus, the device according to the invention enables a slave apparatus to be controlled by a master apparatus without having to transfer a user interface of the slave apparatus or an application run by the slave apparatus. The device according to the invention thus enables either application run at the slave apparatus to be controlled from the master apparatus even if this application is not designed to be run by the master apparatus.

Furthermore, the device according to the invention enables a tactile selection interpreted by the slave apparatus to be performed without having to simulate a pointing device such as a mouse, since the selection is made tactually and directly with respect to an image displayed at the slave apparatus. The device according to the invention is therefore easier and quicker to use than devices of the state of the art.

Further, because it does not have to simulate a pointing device, the device according to the invention is less resource heavy as compared to devices of the state of the art.

Of course, the control image is displayed on the master apparatus on a tactile interface in order to perform a tactile selection relating to this image. The control image is not necessarily displayed by the slave apparatus.

The device according to the invention can further comprise means for determining at least one coordinate of a tactile selection performed on the at least one master apparatus with respect to the at least one control image.

The device according to the invention can further include:
third means for transmitting from the at least one master apparatus to the at least one slave apparatus, the value of at least one physical quantity determined by a sensor of the master apparatus; and
processing means for interpreting said at least one physical quantity at said at least one slave apparatus.

The sensor of the master apparatus can be a physical sensor or a software sensor.

In a particular version, the third transmission means can be the same as the second transmission means.

Advantageously, the at least one control image can comprise an image generated by the at least one slave apparatus for displaying by said at least one slave apparatus, the device according to the invention further comprising screen capture means of at least one slave apparatus.

At least one control image can comprise a visual representation of at least one function accessible on the at least slave apparatus non tactually. A function accessible non-tactually can be for example a function generated by a physical button present on the slave apparatus.

In a particular version, the device according to the invention can further comprise pairing means securing the connection of said at least one master apparatus and said at least one slave apparatus.

These pairing means can enable an undesired connection by a third party apparatus to either or both master and slave apparatuses to be prevented.

Preferably:
the first transmission means,
the means for determining a coordinate of a tactile selection,
the second transmission means, and
the processing means are arranged to be implemented according to a predetermined periodicity. This periodicity can be for example 5 images per second.

In an advantageous version, the device according to the invention can further comprise image processing means performing a processing of the at least one control image before transmission to said at least one master apparatus. The control image transmitted to the master apparatus is in this case the processed control image.

The processing means can be arranged to perform a scaling and/or a sub-sampling.

The device according to the invention can further comprise:
compression means performing a compression of the at least one control image before transmission to the at least one master apparatus; and
decompression means performing a decompression of the at least one compressed control image received by the at least one master apparatus.

In this case, the control image transmitted to the master apparatus is the compressed control image.

In a particular version of the device according to the invention, the transmission means comprise wireless transmission means.

Preferably, the wireless transmission means are secured. This enables an undesired connection by a third party apparatus to either or both master and slave apparatuses to be prevented.

According to another aspect of the invention, it is provided a method for controlling at least one so-called master apparatus, comprising a tactile user interface, said method being in that it comprises the following steps:
transmitting at least one control image, generated by the at least one slave apparatus to said at least one master apparatus for displaying the at least one control image on said at least one master apparatus;
transmitting from the at least one master apparatus to said at least one slave apparatus, at least one coordinate of at least one tactile selection performed on said at least one master apparatus with respect to the at least one control image;
processing said at least one selection at said at least one slave apparatus as a function of said at least one coordinate.

The method according to the invention can further comprise a step of determining at least one coordinate of at least one tactile selection performed on said at least one master apparatus with respect to the at least one control image.

The control image is of course displayed on said master apparatus on a tactile interface.

The control image can be obtained from an image actually displayed on the slave apparatus. In this case, the control image can be obtained by a screen capture of a screen of the slave apparatus or a copy of a graphics memory, or a memory of a graphics board of the slave apparatus.

The control image can be obtained from an image generated by the slave apparatus without being displayed. In this case, the control image can be obtained by a copy of a graphics memory, or a memory of a graphics board of the slave apparatus.

The method according to the invention can further comprise a measurement step during which a physical quantity is sensed by a sensor of the master apparatus.

The sensor can be a physical sensor or a software sensor.

The method can further comprise a step for transmitting, from the at least one master apparatus to the at least one slave apparatus, at least one value of at least one physical quantity and a processing step for interpreting said at least one physical quantity at said at least one slave apparatus.

Preferably, this transmission step can be comprised in or be performed before, after or simultaneously as the step of transmitting at least one coordinate.

Advantageously, the at least one image can comprise an image generated by the at least one slave apparatus for displaying by said at least one slave apparatus, the method according to the invention further comprising a step of capturing a display screen of the slave apparatus.

At least one control image can advantageously comprise a visual representation of at least one function accessible on the slave apparatus non-tactually. A function accessible non-tactually can be for example a function generated by a physical button present on the slave apparatus. Thus, the method according to the invention enables a non-tactile function of the slave apparatus to be moved away.

In an advantageous version, the method according to the invention can further comprise a prior pairing step securing the connection of said at least one master apparatus and at least one said slave apparatus.

This pairing step can enable an undesired connection by a third party apparatus to either or both the master and slave apparatuses to be prevented.

The method can further comprise a notification step preceding a first communication step, during which a visual and/or sound notification is generated to indicate that the at least one master apparatus and the at least slave apparatus are paired. A notification can be generated by the at least one master apparatus and/or the at least one slave apparatus. A visual notification can be displayed on the screen of the master apparatus and/or a screen of the slave apparatus. A sound notification can be emitted by an audio peripheral of the master apparatus and/or the slave apparatus.

Preferably, the steps of:
transmitting the at least one control image from the at least one slave apparatus to the master apparatus, and
displaying said at least one control image on the master apparatus
   are performed according to a predetermined periodicity. This periodicity can be for example 5 control images per second.

The method according to the invention can further comprise an image processing step performing a processing of the at least one control image before the step of transmitting said image to said at least one master apparatus. The control image transmitted to the master apparatus is the processed control image.

The processing performed can be a scaling and/or a sub-sampling.

The method according to the invention can further comprise:
a compression step performing a compression of the at least one control image before the transmission step; and
a decompression step performing a decompression of the at least one compressed control image received by the at least one master apparatus.

In this case, the control image transmitted to the master apparatus is in this case the compressed control image.

Preferably, the at least one transmission between the at least one master apparatus and the at least one slave apparatus is a wireless transmission.

Preferably, the at least one transmission is secured. This can enable an undesired connection by a third party apparatus to either or both master and slave apparatuses to be prevented.

In an advantageous version of the invention, the master and slave apparatuses can both be connected to a same network, for example a local area network, such a network can be wireless such as a Wi-Fi type network. In this case, data exchanges between the master apparatus and the slave apparatus can be performed through this network.

According to another aspect of the invention, it is provided a system comprising:
at least one so-called slave apparatus;
at least one so-called master apparatus, comprising a tactile user interface; and
at least one control device such as set out above for controlling said at least one slave apparatus by said at least one master apparatus.

The first transmission means, and the means for processing the at least one control device can be integrated to the at least one slave apparatus.

This means can besides be in the form of modules connected to the slave apparatus.

The determination means and the second and third transmission means of the at least one control device are integrated to the at least one master apparatus.

This means can besides be in the form of modules connected to the master apparatus.

Preferably, the at least one slave apparatus comprises means for running an operating system for tablet computers such that the master apparatus controls a tactile operating system. In this case, the slave apparatus is seen by the master apparatus as a tactile interface apparatus.

The slave device can further comprise a tactile screen for displaying the tactile user interface.

Preferably, the at least one slave device and/or at least one master device is a tactile screen tablet computer.

The master device can also be a portable phone with a tactile screen.

### DESCRIPTION OF THE FIGURES AND EMBODIMENTS

Further advantages and features of the invention will appear upon reading the detailed description of implementations and an embodiment in no way limiting, and the following appended drawings wherein:

FIG. 1 is a schematic representation of a first embodiment of a system according to the invention;

FIG. 2 is a schematic representation of a second embodiment of a system according to the invention;

FIG. 3 is a schematic representation of a third embodiment of a system according to the invention;

FIG. 4 is a schematic representation of a fourth embodiment of a system according to the invention;

FIG. 5 is a diagrammatic representation of a method according to the invention; and

FIG. 6 is a schematic representation of a configuration of use of a system according to the invention.

In the figures, an element appearing on several figures keeps the same reference.

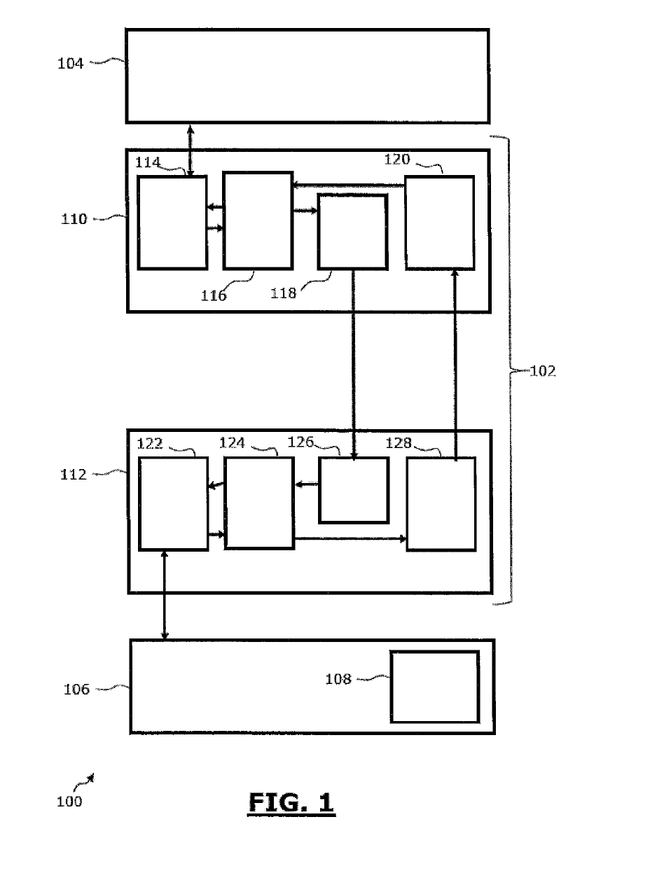

FIG. 1 is a schematic representation of a first embodiment of a system according to the invention.

The system 100, represented in FIG. 1, comprises a control device 102, a slave apparatus 104 and a master apparatus 106 comprising a tactile interface 108 used for controlling the slave apparatus 104 through the control device 102.

The device 102, represented in FIG. 1, comprises a so-called slave module 110, on the slave apparatus 104 side, and a second so-called master module 112, on the master apparatus 106 side.

The slave module 110 comprises:
a module 114 for communicating with the slave apparatus 104, enabling data to be sent and received to/from the slave apparatus 104,
a processing module 116,
a module 118 for sending data to the master module 112, and
a module 120 for receiving data sent by the master module 112.

The master module 112 comprises:
a module 122 for communicating with the master apparatus 106, enabling data to be sent and received to/from the master apparatus 106,
a processing and calculating module 124,
a module 126 for receiving data sent by the slave module 110, and
a module 128 for sending data to the slave module 110.

A control image is transmitted by the slave apparatus 104 to the communication module 114 of the slave module 110. This control image is transmitted to the processing module 116 of the slave module 110.

The control image is processed by this module which performs:
a sub-sampling of the control image to reduce its size,
a compression of the control image, and
possibly any other desired processing.

The control image thus processed is transmitted to the module 118 for sending data to the master module 112, which sends it to the master module 112.

The data receiving module 126 of the master module 112 receives this control image and transfers it to the processing and calculating module 124. The control image compressed beforehand is decompressed by the processing and calculating module 124 and undergoes any other desired processing and performed by this processing and calculating module 124.

The processed control image is communicated to the communication module 122 which transfers it to the master apparatus 106 for displaying by the tactile interface 108.

The master apparatus 106 displays the control image for a tactile selection on this control image.

When a tactile selection is performed by a user on the tactile interface 108 of the master apparatus 106, data of this tactile selection are transmitted by the master apparatus 106 to the master module 112 through the communication module 122 of the master module 112. The selection data are sent to the processing and calculating module 124 which determines the coordinate(s) of this tactile selection.

The determined coordinate(s) is (are) then sent to the slave module 110 through the module 128 for sending data to the slave module 110.

The slave module receives the coordinate(s) through the module 120 for receiving data sent by the master module 112.

The coordinate(s) is (are) interpreted by the processing module 116 of the slave module 110 to determine a function associated with the tactile selection performed relative to the control image.

The determined function is then transmitted to the slave apparatus 104 through the module 114 for communicating with the slave apparatus 104.

The slave apparatus 104 then performs this function.

Thus, the slave apparatus 104 is controlled by the master apparatus 106.

In addition to the selection coordinate(s), the value of one or more physical quantities, measured by one or several sensors (not. represented) of the master apparatus 106 can also be transmitted to the slave module 110 by the master module 112, in the same way as the coordinate(s) of a tactile selection.

The control image can be an image located in a graphics memory or a display memory or even a graphics board of the slave apparatus which is communicated to the slave apparatus that is an image generated by a screen capture module (not represented) situated in the slave apparatus or in the slave module. In the latter case, it is the screen capture module that generates the control image by a screen capture of the slave apparatus.

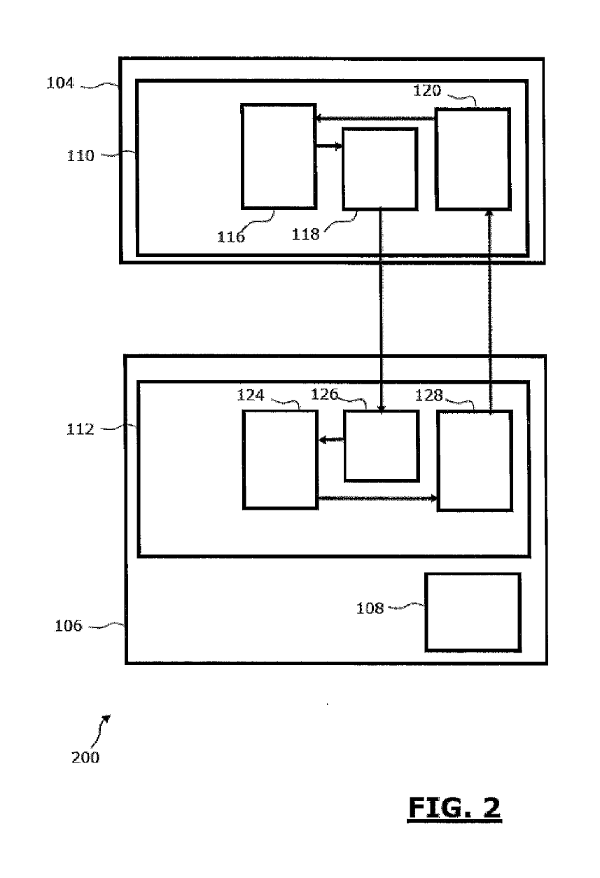

FIG. 2 is a schematic representation of a second embodiment of a system according to the invention.

In the system 200, represented in FIG. 2, the slave module 110 is integrated in the slave apparatus 104, and the master module 112 is integrated in the master apparatus 106.

In this embodiment, the slave module 110 does not comprise a module for communicating with the slave apparatus 104 since it is integrated in the slave apparatus 104 and the master module 112 does not comprise a module for communicating with the master apparatus 106 since it is integrated in the master apparatus 112.

In this embodiment, each module of the device according to the invention can be a software module or an electronic module using calculating means such as a calculator or a processor, already present on the slave apparatus or the master apparatus.

Furthermore, the modules for sending and receiving data, taken singly, can be modules existing in the slave apparatus or the master apparatus and which are arranged to perform the desired operations.

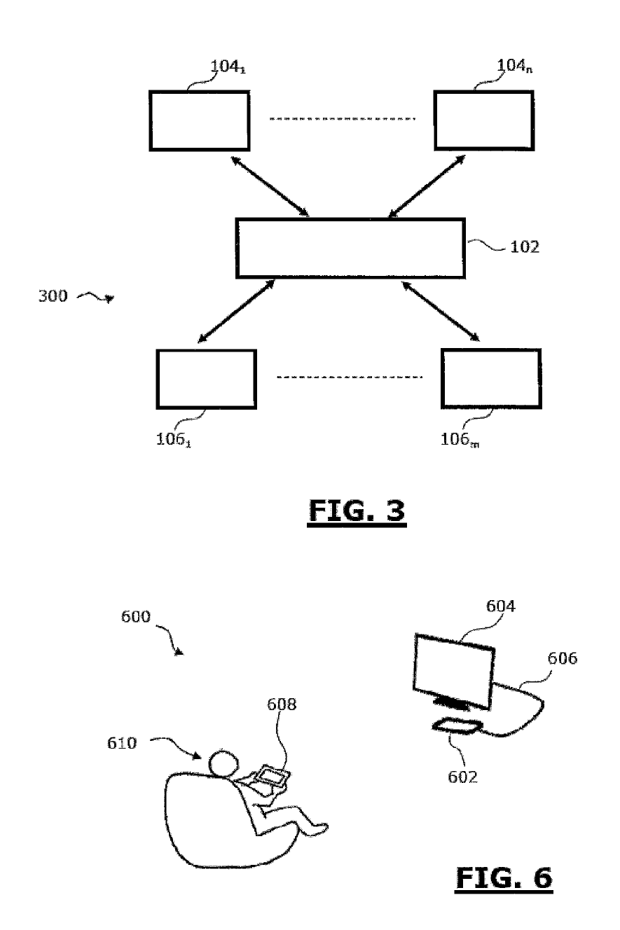

FIG. 3 is another embodiment of a system according to the invention.

In the system 300 represented in FIG. 3, a control device 102 is used for controlling one or more slave apparatuses 104l-104n by one or more master apparatuses 106l-106m, with n and m being non zero positive integers.

Obviously, the control device 102 could comprise several slave modules 110l-110n respectively affected to the slave apparatuses 104l-104n. On the other hand, or in combination with the above in this paragraph, the control device, 102 could also comprise several master modules 112l-112n respectively affected to the master apparatuses 106l-106n.

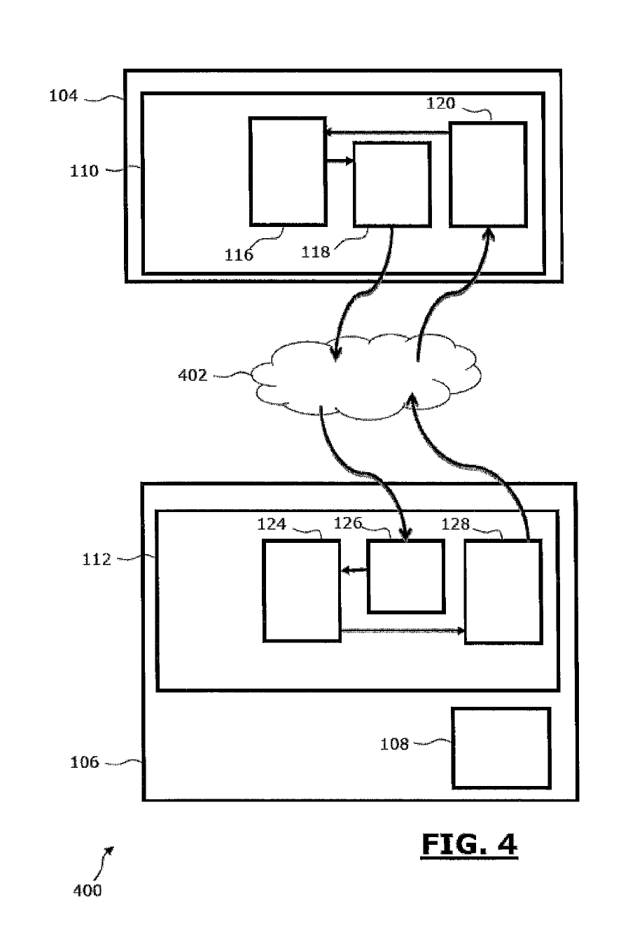

FIG. 4 is a schematic representation of a fourth embodiment of a system according to the invention.

FIG. 4 consists of the same elements as FIG. 2 except that in the system 400 represented in FIG. 4, a communication network 402 is used for transmitting, that is receiving and emitting, data from one of the apparatuses to the other.

The embodiment 400 is the preferred embodiment of the invention.

This computer network is a wireless network. It can include one or more wireless routers.

The communication network could be wired and include one or more wired routers. It could also be a mixture of wireless and wired routers.

In a preferred embodiment, the communication network is a local area network, such as a home network or a corporate network.

The communication network can also be a global network, of the Internet type.

Of course, the computer network 402 could also be introduced and used in all the embodiments of a system according to the invention previously described.

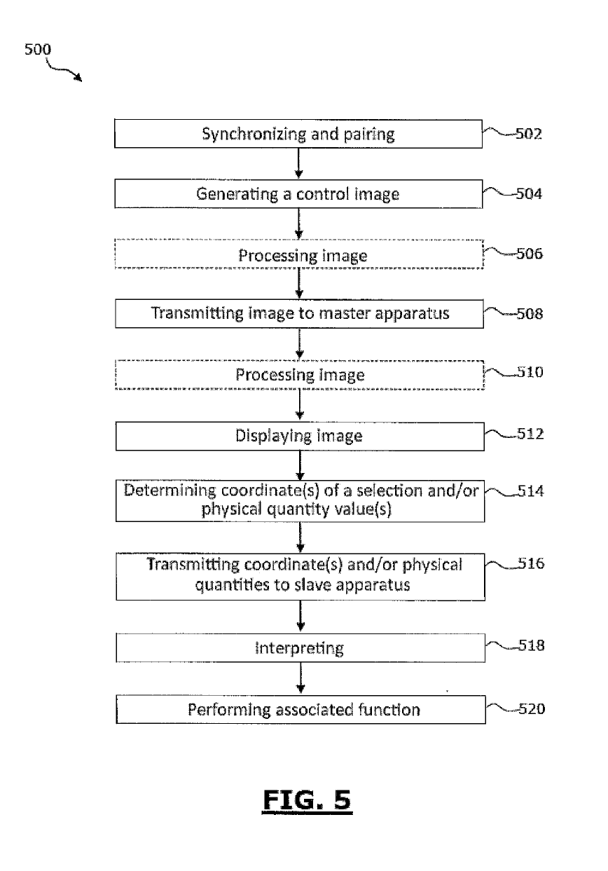

It will now be described an exemplary method according to the invention in reference to FIG. 5.

The method 500 represented in FIG. 5 comprises a first step 502 of synchronizing and pairing the master and slave apparatuses and establishing a secured connection.

Once the connection is establishing, the method 500 comprises a step of generating a control image in step 504.

This image is generate either by performing a screen capture of the master apparatus, or communicated by the slave apparatus from a display memory or a graphics board.

The control image is possibly processed in step 506. The processing can comprise a compression and/or a sub-sampling or a scaling. This step 506 is an optional step.

The control image is then sent to the master apparatus in step 508.

The received control image is decompressed or rescaled in step 510 to be decompressed if such a compression has been performed during the optional step 506.

The master apparatus displays the control image in step 512.

Following a tactile selection performed on the tactile interface of the master apparatus with respect to the displayed control image, the coordinate(s) of the selection is (are) determined as well as one or several values of one or several physical parameters such as the selection rate, the angle of the master apparatus in a given direction, the depressing power for the tactile selection, etc. in step 514.

The coordinate(s) and possibly the physical parameter(s) are transmitted to the slave apparatus in step 516.

The slave apparatus performs an interpretation of coordinate(s) and possibly of the received parameter(s) to identify the function(s) associated with the tactile selection and possibly the physical parameter(s) in step 518.

In step 520, the identified function(s) is (are) run by the slave apparatus.

Steps 504 to 512 are performed with a predetermined frequency, such as for example 5 times per second.

Steps 514 to 520 are performed following each tactile selection performed at the master apparatus.

The method 500 is initiated at the request of a user by selecting a pairing function at the master apparatus or the slave apparatus. The choice of the other apparatus can be manually performed or by a selection of the other apparatus in a menu displayed on the first apparatus.

FIG. 6 is a schematic representation of a configuration 600 implementing a system according to the invention in compliance with the embodiment of FIG. 2.

In the configuration 600 represented in FIG. 5, the slave apparatus is a tablet 602 connected to a television 604 by an HDMI cable 606 and the master apparatus is a tactile screen apparatus 608.

The table 602 is a tactile screen tablet using the Android applicative platform having an HDMI output enabling it to be connected to a television. An exemplary tablet of this type is an ARCHOS 10.1 Internet tablet. This tablet has a 10.1″ tactile screen having a resolution of 1024×600 pixels. The tablet could use another applicative platform based on a tactile user interface paradigm.

The tactile screen apparatus 608 is a smartphone type mobile phone for example an Apple iPhone or a phone using the Android platform such as for example the Google Nexus One phone. The apparatus can also be another tablet. In the case of a Google Nexus One phone, the apparatus has a tactile screen having a dimension 3.7″ and a resolution of 800×480 pixels.

A user 610 looks at the contents displayed on the television at some distance, typically 2 to 4 metres, which is the typical distance at which a television viewer sits. The user holds the tactile screen apparatus in his/her hands.

The tablet 602, connected to the television 604, has a wireless communication interface for example according to one of the Wi-Fi (IEEE 802.11) or Bluetooth (802.15.1-3) standards. The apparatus 608 located in the user's hands has a wireless communication interface which can communicate according to the same standard as that of the tablet 602.

The tablet 602, thanks to the use of the Android platform, is based on a user interface paradigm based on several sensors, mainly the tactile screen, but also accelerometers, gyroscopes and compasses.

This paradigm is distinguishable from that of a computer mouse in that the interaction is directly made on the screen where the user will directly touch the screen surface to trigger actions. In the computer mouse paradigm, the user moves a mouse on a distinct surface of the screen. This movement is materialized on a screen by a cursor which is superimposed on the screen. When the cursor is at the desired place, the user can trigger an action by clicking.

On the other hand, the use of the Android platform enables the user to install on the slave apparatus a great number of applications developed by an active ecosystem of developers. These applications are designed to use the particular user interface paradigm.

When the user is at some distance from the tablet 602, he cannot interact with the applications according to the intended paradigm.

The invention allows this interaction through the apparatus 608.

The apparatus 608 is in the user's hands. Given that it has the same sensors as the slave apparatus, it could be used, vicariously, as a remote control for the tablet 602.

In the configuration 600 represented in FIG. 5, the control device consists of softwares, being master software and slave software, run by the apparatus 608 which is the master apparatus and by the tablet 602 which is the slave apparatus. These softwares ensure the pairing of the tablet 602 and the apparatus 608 according to a predetermined pairing protocol, the bidirectional communication between both apparatuses as well as the capture of user's actions on the apparatus 608 and the restoration of these actions on the tablet 602. The slave software is run as a background task.

According to the invention, the master and slave apparatuses can both be connected to a same network, for example a local area network, such a network can be wireless such as a Wi-Fi type network.

The slave software is run on the slave apparatus either automatically upon starting the apparatus, or automatically when the apparatus is connected to the TV by the HDMI link or manually by the user.

The dedicated master software is run on the master apparatus manually by the user. The user selects the pairing mode in a menu of the master software. The software will search on the Wi-Fi local area network for the available slave apparatuses and display their name in a list. The user then selects the slave apparatus he/she wants to be control. The master software asks the user to enter a password. And then, it starts communication with the slave software of the slave apparatus selected to inform it that a master apparatus tries to pair with it and provides it with the password. The slave software receives the password and asks the user to enter the password. If the password entered by the user is identical to the password communicated by the master apparatus, then the pairing is performed.

It is obvious that other passwords exchange modes can exist, such for example a communication of the password from the slave to the master, a coding of the password, etc.

When the pairing is actual, a visual notification of the pairing is displayed by the slave apparatus on the TV screen.

In a first embodiment, the master software displays controls (buttons) on the screen of the master apparatus. These buttons adopt the standard buttons of the Android interface, that is “Home”; “Sack”; “Search”; “Menu”; “Up”; “Down”, “Left”, “Right”; “Select”.

When the user depresses one of these buttons, the master software communicates this Event to the slave software. The slave software triggers the corresponding Android event in the slave apparatus. The operating system of the slave apparatus is thus stimulated as if a user had depressed the corresponding button of the slave apparatus.

In a second mode of use, it is attempted to have a finer control of the slave apparatus by the master apparatus in particular when the application run on the slave apparatus cannot be controlled by the 9 Android standard buttons. This is the case of a number of games, softwares for reading multimedia contents, Internet browser. In these applications, a control by the tactile interface is necessary.

In this second embodiment, the slave software captures the frame buffer of the slave apparatus. This image is sent to the master software which displays it onto the screen of the master apparatus.

These operations are periodically performed at a frequency of 5 screen captures per second.

The user can thus view on the screen of the master apparatus a copy of the screen of the slave apparatus. He has thus a representation of the user interface of the slave apparatus available on the screen of the master apparatus and is guided in the tactile interaction. The master software detects all the tactile events performed by the user on the screen of the master apparatus and communicates them to the slave software. The slave software triggers the corresponding Android events in the slave apparatus. The operating system of the slave apparatus is thus stimulated as if a user had performed the same tactile events on the screen of the slave apparatus.

An adaptation of the image captured onto the slave apparatus can be performed when the screen resolutions are not necessarily identical between both apparatuses. On the other hand, the transmission mode can include reduction mechanisms of the bandwidth in the communication channel. These mechanisms can be: a time and/or space sub-sampling of the image, a compression of the image (for example JPEG or PNG), a transmission of the differences in successive images which is associated to a quantification and an arithmetic or “run-length” (RLE) type coding, etc . . . .

On the other hand, it can be desirable to reserve part of the screen of the master apparatus to dispose control buttons such as for example the standard Android control buttons. The area for displaying the capture image will then be smaller than the surface area of the screen of the master apparatus. In both operating modes described above, it can be contemplated that the master software detects events related to other sensors of the master apparatus (accelerometers; gyroscopes, compasses, . . . ), transmits them the slave software which in turn triggers the corresponding Android events in the slave apparatus. The operating system of the slave apparatus is thus stimulated as if a user had performed the same tactile events on the slave apparatus.

In a different implementation, the slave apparatus can be an interactive television or equivalently an apparatus without a screen connected to a TV. An example of such an apparatus is a set-top-box or TV Cam. In this implementation, the slave apparatus uses the applicative platform Android, or generally another applicative platform based on a tactile user interface paradigm.

Of course, the invention is not restricted to the examples just described and numerous alterations can be provided to these examples without departing from the scope of the invention.

1. A device for controlling at least one so-called slave apparatus, by at least one so-called master apparatus, including a tactile user interface, said device comprising:
first means for transmitting at least one so-called controlled image, generated by the at least one slave apparatus to said at least one master apparatus for displaying the at least one controlled image on said at least one master apparatus;
second means for transmitting, from said at least one master apparatus to said at least one slave apparatus, at least one coordinate of at least one tactile selection performed on said at least one master apparatus with respect to said at least one controlled image; and
processing means for interpreting said at least one tactile selection at said at least one slave apparatus as a function of said at least one coordinate.

2. The device according to claim 1, characterised in that if further comprises:
third means for transmitting from the at least one master apparatus to the at least one slave apparatus, at least one physical quantity determined by a sensor of the master apparatus; and
processing means for interpreting said at least one physical quantity at said at least one slave apparatus.

3. The device according to claim 1, characterised in that the at least one controlled image comprises an image generated by the at least one slave apparatus for displaying by said at least one master apparatus, said device further comprising screen capture means of the at least one slave apparatus.

4. The device according to claim 1, characterised in that said at least one controlled image comprises a visual representation of at least one function accessible on the at least slave apparatus non tactually.

5. The device according to claim 1, characterised in that it further comprises pairing means securing the connection of said at least one master apparatus and said at least one slave apparatus.

6. The device according to claim 1, characterised in that the first transmission means, the means for determining at least one coordinate of at least one tactile selection, the second transmission means and processing means are arranged to be implemented according to a predetermined periodicity.

7. The device according to claim 1, characterised in that it further comprises image processing means performing a processing of the at least one controlled image before transmission to the at least one master apparatus.

8. The device according to claim 1, characterised in that it further comprises:
compression means performing a compression of the at least one controlled image before transmission to the at least one master apparatus; and
decompression means performing a decompression of the at least one compressed controlled image received by the at least one master apparatus.

9. The device according to claim 1, characterised in that the transmission means comprise wireless transmission means.

10. A method for controlling at least one so-called slave apparatus, by at least one so-called master apparatus, comprising a tactile user interface, said method comprising the following steps:
transmitting at least one so-called controlled image, generated by the at least one slave apparatus to said at least one master apparatus for displaying the at least one controlled image on said at least one master apparatus;
transmitting from the at least one master apparatus to said at least one slave apparatus, at least one coordinate of at least one tactile selection performed on said at least one master apparatus with respect to the at least one controlled image;
processing said at least one selection at said at least one slave apparatus as a function of said at least one coordinate.

11. The method according to claim 10, characterised in that it further comprises a step of transmitting from said at least one master apparatus to said at least one slave apparatus at least one physical quantity sensed by a sensor of the at least one master apparatus and a step of processing for interpreting said at least one physical quantity at said at least one slave apparatus.

12. The method according to claim 10, characterised in that the at least one controlled image comprises an image generated by at least one slave apparatus for displaying by said at least one master apparatus, said method further comprising a screen capture step of the slave apparatus.

13. The method according to claim 10, characterised in that the at least one controlled image comprises a visual representation of at least one function accessible on the slave apparatus non-tactually.

14. The method according to claim 10, characterised in that it further comprises a prior pairing step securing the connection of said at least one master apparatus and at least one slave apparatus.

15. The method according to claim 10, characterised in that at least one transmission between the at least one master apparatus and the at least one slave apparatus is secured.

16. The method according to claim 10, characterised in that the steps of:
transmitting the at least one controlled image from the at least one slave apparatus to the master apparatus, and
displaying said at least one controlled image on the master apparatus are performed according to a predetermined periodicity.

17. The method according to claim 10, characterised in that it further comprises an image processing step performing an image processing of the at least one controlled image before the step of transmitting said controlled image to said at least one master apparatus.

18. The method according to claim 10, characterised in that it further comprises:
a compression step performing a compression of the at least one controlled image before the transmission step; and then
a decompression step performing a decompression of the at least one compressed controlled image received by the at least one master apparatus.

19. A system comprising:
at least one so-called slave apparatus;
at least one so-called master apparatus, comprising a tactile user interface; and
at least one control device according to claim 1 for controlling said at least one slave apparatus by said at least one master apparatus.

20. The system according to claim 19, characterised in that:
the first transmission means, and
a processing means
of the at least one control device are integrated to the at least one slave apparatus.

21. The system according to claim 19, characterised in that:
the means for determining a coordinate,
the second transmission means, and
a third transmission means;
of the at least one control device are integrated to the at least one master apparatus.

22. The system according to claim 19, characterised in that the at least one slave apparatus comprises means for running an operating system for tablet computers so that the master apparatus controls a tactile operating system.

23. The system according to claim 22, characterised in that the at least one slave device further comprises a screen for displaying the tactile user interface.

24. The system according to claim 19, characterised in that the at least one slave device and/or at least one master device is a tablet computer.
